(19) United States
(12) Patent Application Publication
(10) Pub. No.: US 2019/0155344 A1
(43) Pub. Date: May 23, 2019

(54) DUAL-AXLE HINGE AND ELECTRONIC DEVICE

(71) Applicants: Che-Hsien Lin, Taipei City (TW); Che-Hsien Chu, Taipei City (TW)

(72) Inventors: Che-Hsien Lin, Taipei City (TW); Che-Hsien Chu, Taipei City (TW)

(73) Assignee: COMPAL ELECTRONICS, INC., Taipei City (TW)

(21) Appl. No.: 16/198,745

(22) Filed: Nov. 21, 2018

Related U.S. Application Data
(60) Provisional application No. 62/589,571, filed on Nov. 22, 2017.

(51) Int. Cl. G06F 1/16; E05D 3/12

(52) U.S. Cl. CPC G06F 1/1681; E05Y 2900/606; E05D 3/12; G06F 1/1618

(57) ABSTRACT

A dual-axle hinge is provided. The dual-axle hinge includes a first shaft, a second shaft, a first fixing member, and a torque assembly. The first fixing member includes a first through hole, a second through hole, a first positioning hole, and a second positioning hole between the first through hole and the second through hole. The torque assembly includes a first torque adjustment portion, a second torque adjustment portion, a middle portion, a first positioning protrusion, and a second positioning protrusion. The first torque adjustment portion and the second torque adjustment portion are connected to two sides of the middle portion respectively, and the first positioning protrusion and the second positioning protrusion are disposed at the middle portion respectively and protrude toward the first positioning hole and the second positioning hole. The disclosure further provides an electronic device.

### CROSS-REFERENCE TO RELATED APPLICATION

This application claims the priority benefit of U.S. provisional application Ser. No. 62/589,571, filed on Nov. 22, 2017. The entirety of the above-mentioned patent application is hereby incorporated by reference herein and made a part of this specification.

### BACKGROUND OF THE INVENTION

### Technical Field

The disclosure relates to a hinge and an electronic device, and more particularly, to a dual-axle hinge and an electronic device.

### Description of Related Art

With advances in technology, many types of portable electronic devices are being brought out, such as a laptop computer. In modern society, these electronic devices have become a necessity in people's lives.

For the laptop computer, a hinge is disposed between a top cover of a screen and a host so that the laptop computer can be open and closed. However, most of the current hinges are designed to have a single axle, making it difficult for the top cover of the laptop computer to rotate 360 degrees with respect to the host.

### SUMMARY OF THE INVENTION

The disclosure provides a dual-axle hinge capable of rotating 360 degrees and rotating more securely.

The disclosure provides an electronic device including a dual-axle hinge. A top cover of the electronic device is pivoted to the host through the dual-axle hinge, so the electronic device can rotate 360 degrees more securely.

The dual-axle hinge of the disclosure includes a first shaft, a second shaft, a first fixing member, and a torque assembly. The first fixing member includes a first through hole, a second through hole, a first positioning hole and a second positioning hole that are located between the first through hole and the second through hole. The torque assembly includes a first torque adjustment portion, a second torque adjustment portion, a middle portion, a first positioning protrusion and a second positioning protrusion. The first torque adjustment portion and the second torque adjustment portion are connected to two sides of the middle portion respectively, and the first positioning protrusion and the second positioning protrusion are disposed at the middle portion respectively and protrude toward the first positioning hole and the second positioning hole. The first torque adjustment portion has a first groove, the second torque adjustment portion has a second groove, the first shaft passes through the first through hole and the first groove sequentially, and the second shaft passes through the second through hole and the second groove sequentially.

The electronic device of the disclosure includes a top cover, a host and the above dual-axle hinge through which the top cover is pivoted to the host.

In an embodiment of the disclosure, the above dual-axle hinge further includes a second fixing member, the torque assembly is located between the first fixing member and the second fixing member, the second fixing member includes a third through hole, a fourth through hole, a third positioning hole and a fourth positioning hole that are located between the third through hole and the fourth through hole, the torque assembly includes a third positioning protrusion and a fourth positioning protrusion that are fixed to the third positioning hole and the fourth positioning hole respectively, the first shaft passes through the first through hole, the first groove and the third through hole sequentially, and the second shaft passes through the second through hole, the second groove and the fourth through hole sequentially.

In an embodiment of the disclosure, the third positioning protrusion and the fourth positioning protrusion are located at the middle portion respectively and protrude toward the second fixing member.

In an embodiment of the disclosure, the first torque adjustment portion and the second torque adjustment portion have plate-like structures, and the first groove and the second groove are formed by being surrounded by the first torque adjustment portion and the second torque adjustment portion respectively from two sides of the middle portion along the same rotational direction.

In an embodiment of the disclosure, the middle portion includes a first base and a second base that are separated. The first torque adjustment portion extends from the first base, the first positioning protrusion and the third positioning protrusion are formed on the first base respectively and protrude toward the first fixing member and the second fixing member respectively, the second torque adjustment portion extends from the second base, and the second positioning protrusion and the fourth positioning protrusion are formed on the second base respectively and protrude toward the first fixing member and the second fixing member respectively.

In an embodiment of the disclosure, the first shaft includes a first blocking portion that includes a first surface and a second surface, and the second shaft includes a second blocking portion that includes a third surface and a fourth surface. The first fixing member includes a third blocking portion and a fourth blocking portion that correspond to the first blocking portion and the second blocking portion respectively, the third blocking portion includes a first blocking surface and a second blocking surface that can abut against the first face and the second face respectively, and the fourth blocking portion includes a third blocking surface and a fourth blocking surface that can abut against the third surface and the fourth surface respectively.

In an embodiment of the disclosure, when the top cover and the host are in a first closed position, a bottom surface of the top cover faces a top surface of the host, the first surface abuts against the first blocking surface, and the fourth surface abuts against the fourth blocking surface. When the top cover is rotated with respect to the host from the first closed position along the same direction as a surrounding direction of the first torque adjustment portion, the torque assembly rotates around the second shaft that serves as an axis until the top cover rotates with respect to the host by a first angle, the third surface abuts against the third blocking face, and the first surface abuts against the first blocking face.

In an embodiment of the disclosure, when the third surface abuts against the third blocking surface, and the top cover is rotated with respect to the host along the same direction as the surrounding direction of the first torque adjustment portion, the torque assembly rotates with the first shaft that serves as an axis. The top cover and the host are in a second closed position, and the second surface abuts against the second blocking surface until a top surface of the top cover faces a bottom surface of the host.

In an embodiment of the disclosure, the dual-axle hinge further includes at least two buckles. The first shaft includes a first engaging groove, the second shaft includes a second engaging groove, and the buckles and the torque assembly are located at opposite sides of the second fixing member, and the buckles are disposed in the first engaging groove of the first shaft and the second engaging groove of the second shaft respectively.

In an embodiment of the disclosure, the dual-axle hinge further includes a casing and a locking member, and the second fixing member further includes a screw hole that is located between the third positioning hole and the fourth positioning hole. The casing houses the first shaft, the second shaft, the first fixing member, the torque assembly and the second fixing member, and the locking member passes through the casing to be locked to the screw hole of the second fixing member.

In view of the above, the dual-axle hinge of the electronic device of the disclosure allows the top cover and the host of the electronic device to rotate 360 degrees with respect to each other. In addition, with the first positioning protrusion and the second positioning protrusion disposed at the middle portion respectively and protruding toward the first positioning hole and the second positioning hole, the torque assembly can be fixed to the first positioning hole and the second positioning hole of the first fixing member. Accordingly, the torque assembly can be desirably and securely fixed to the first fixing member.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 schematically illustrates a portable electronic device having a dual-axle hinge according to a first embodiment of the disclosure.

FIG. 2 schematically illustrates a dual-axle hinge of the disclosure.

FIG. 3 is an exploded view of components of the dual-axle hinge of FIG. 2.

FIGS. 4A and 4B are side views of a torque assembly of the disclosure.

FIGS. 5A and 5B are side views of a first shaft and a second shaft of the disclosure.

FIG. 6 is a side view of a first fixing member of the disclosure.

FIGS. 7A to 7C schematically illustrate an operation sequence of an electronic device according to the first embodiment of the disclosure.

FIGS. 8A to 8C are cross-sectional views showing an operation sequence of a torque assembly of the dual-axle hinge.

FIGS. 9A to 9C are cross-sectional views showing an operation sequence of a blocking portion of the dual-axle hinge.

FIGS. 10A to 10D schematically illustrate an operation sequence of an electronic device according to a second embodiment of the disclosure.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

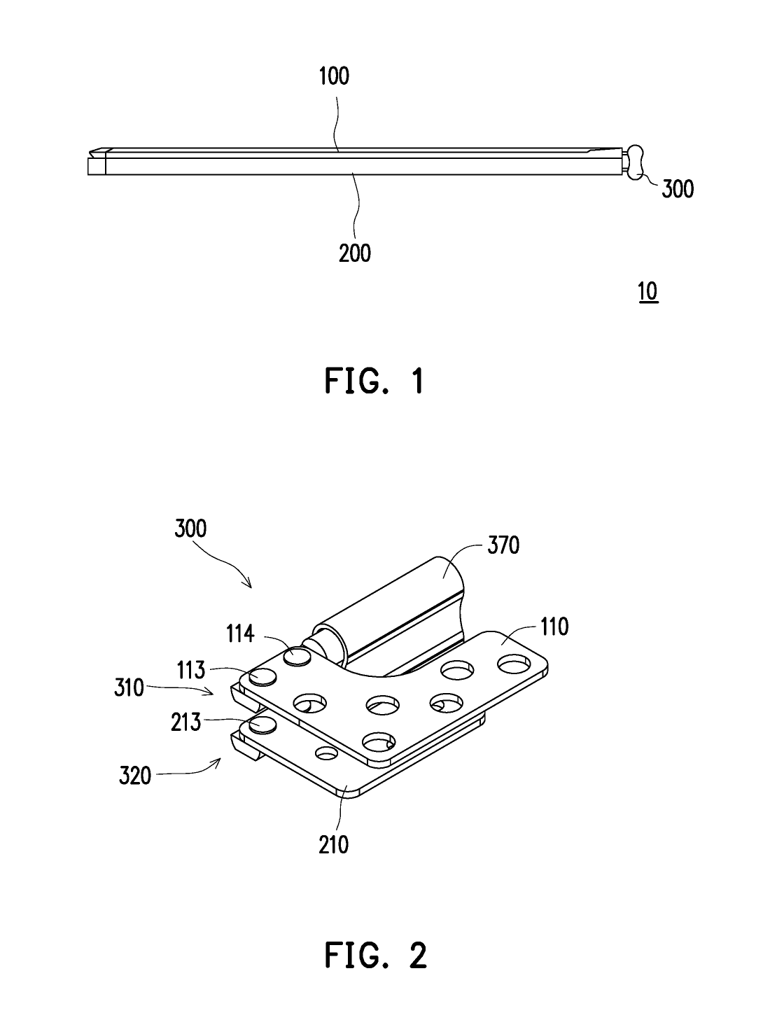

FIG. 1 schematically illustrates a portable electronic device having a dual-axle hinge according to a first embodiment of the disclosure. Referring to FIG. 1, a portable electronic device 10 according to the embodiment includes a top cover 100, a host 200 and a dual-axle hinge 300. The electronic device 10 can be, for example, a laptop computer. The top cover 100 can be, for example, a screen display or touch panel. The host 200 has an operating area such as a keyboard module, etc. The top cover 100 of the electronic device 10 may be pivoted to the host 200 through the dual-axle hinge 300.

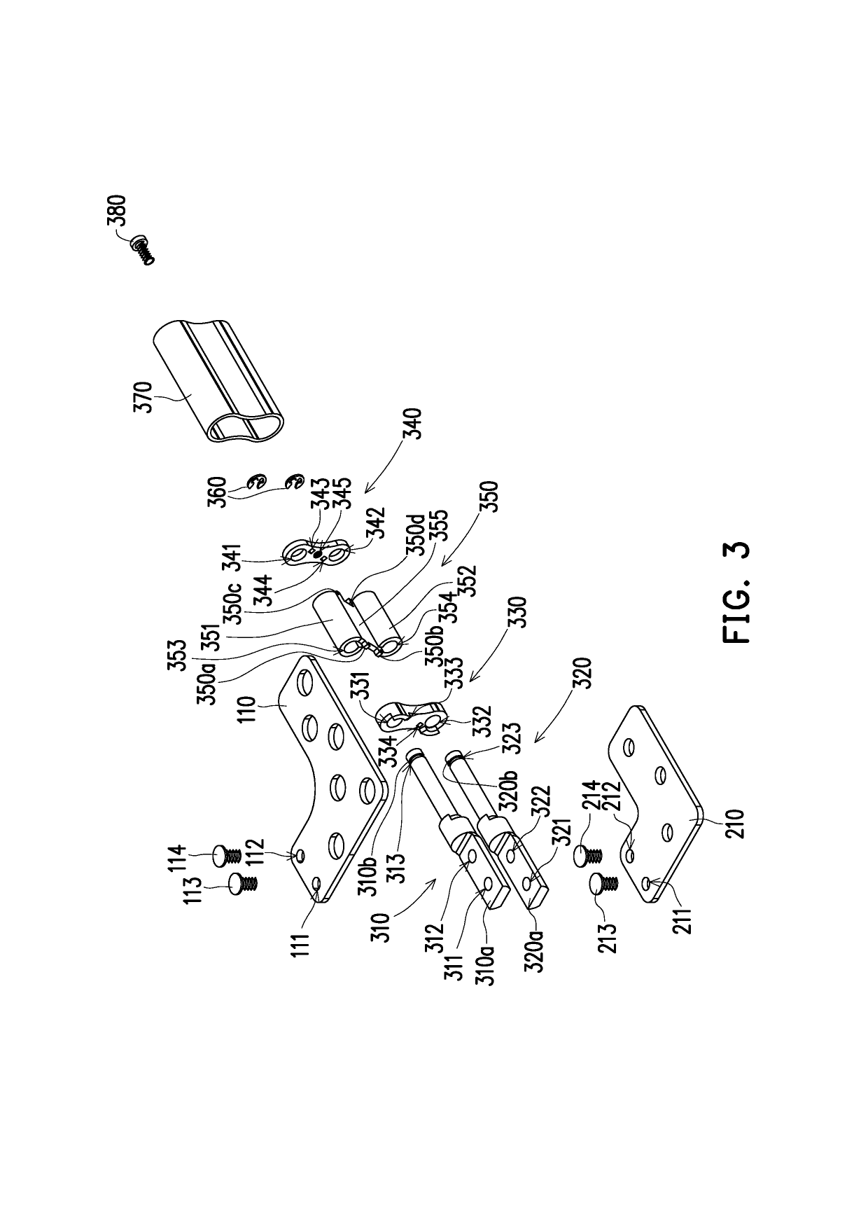

FIG. 2 schematically illustrates a dual-axle hinge of the disclosure. FIG. 3 is an exploded view showing assemblies of the dual-axle hinge of FIG. 2. Referring to FIG. 3, the dual-axis hinge 300 according to the present embodiment includes a first shaft 310, a second shaft 320, a first fixing member 330 and a torque assembly 350. A first end portion 310a of the first shaft 310 has a first opening 311 and a second opening 312, and a first end portion 320a of the second shaft 320 has a third opening 321 and a fourth opening 322.

A first locking sheet 110 has a first locking hole 111 and a second locking hole 112 that are aligned with the first opening 311 and the second opening 312 respectively, and is fixed to the first opening 311 and the second opening 312 through a first fixing member 113 and a second fixing member 114 penetrating the first locking hole 111 and the second locking hole 112 respectively. A second locking sheet 210 has a third locking hole 211 and a fourth locking hole 212 that are aligned with the third opening 321 and the fourth opening 322 respectively, and is fixed to the third opening 321 and the fourth opening 322 through a third fixing member 213 and a fourth fixing member 214 penetrating the third locking hole 211 and the fourth locking hole 212 respectively.

In the present embodiment, the first locking member 113, the second locking member 114, the third locking member 213, and the fourth locking member 214 are, for example, screws or rivets, which are secured by being screwed into a hole or placed in a hole to be riveted, but the disclosure is not limited thereto. The first locking sheet 110 is connected to the top cover 100, the second locking sheet 210 is connected to the host 200, and the top cover 100 and the host 200 are connected to the dual-axle hinge 300 through the first locking sheet 110 and the second locking sheet 210, so that the top cover 100 and the host 200 can rotate to be open or closed by the torque of the dual-axle hinge 300.

The first fixing member 330 includes a first through hole 331, a second through hole 332, a first positioning hole 333 and a second positioning hole 334 that are located between the first through hole 331 and the second through hole 332 (see FIG. 6). The dual-axle hinge 300 according to the present embodiment may further optionally include a second fixing member 340. The second fixing member 340 includes a third through hole 341, a fourth through hole 342, a third positioning hole 343 and a fourth positioning hole 344 that are located between the third through hole 341 and the fourth through hole 342. The first fixing member 330 and the second fixing member 340 are located at two sides of the torque assembly 350 respectively.

The torque assembly 350 according to the present embodiment is located between the first fixing member 330 and the second fixing member 340 and has a first torque adjustment portion 351, a second torque adjustment portion 352, a middle portion 355, a first positioning protrusion 350a and a second positioning protrusion 350b. The first positioning protrusion 350a and the second positioning protrusion 350b are fixed to the first positioning hole 333 and the second positioning hole 334 respectively. In an embodiment, the torque assembly 350 further has a third positioning protrusion 350c and a fourth positioning protrusion 350d that are fixed to the third positioning hole 343 and the fourth positioning hole 344 respectively.

The first torque adjustment portion 351 has a first groove 353 that is aligned with the first through hole 331 and the third through hole 341 and sleeves the first shaft 310, and the second torque adjustment portion 352 has a second groove 354 that is aligned with the second through hole 332 and the fourth through hole 342 and sleeves the second shaft 320.

The dual-axle hinge 300 according to the present embodiment further includes at least two buckles 360, a second end portion 310b of the first shaft 310 has a first engaging groove 313, a second end portion 320b of the second shaft 320 has a second engaging groove 323, the buckle 360 and the torque assembly 350 are located at opposite sides of the second fixing member 340 respectively, and the two buckles 360 are disposed in the first engaging groove 313 and the second engaging groove 323, respectively.

In detail, the first shaft 310 penetrates the first through hole 331, the first groove 353 and the third through hole 341 sequentially by the second end portion 310b, and the buckle 360 is disposed in the first engaging groove 313, so that the first shaft 310 is prevented from being detached from the first fixing member 330, the second fixing member 340 and the torque assembly 350. Similarly, the second shaft 320 penetrates the second through hole 332, the second groove 354 and the fourth through hole 342 sequentially by the second end portion 320b, and the buckle 360 is disposed in the second engaging groove 323, so that the second shaft 320 is prevented from being detached from the first fixing member 330, the second fixing member 340 and the torque assembly 350.

In the present embodiment, through the first positioning protrusion 350a and the second positioning protrusion 350b that are fixed to the first positioning hole 333 and the second positioning hole 334 respectively and the third positioning protrusion 350c and the fourth positioning protrusion 350d that are fixed to the third positioning hole 343 and the fourth positioning hole 344 respectively, the torque assembly 350 can be desirable and securely fixed to the first fixing member 330 and the second fixing member 340 at two sides. In addition, the above design can also reduce the likelihood that the torque applied to the first shaft 310 by the first torque adjustment portion 351 and the torque applied to the second shaft 320 by the second torque adjustment portion 352 affect each other.

In addition, the dual-axle hinge 300 according to the present embodiment further includes a casing 370 and a locking member 380. The second fixing member 340 further has a screw hole 345 between the third positioning hole 343 and the fourth positioning hole 344. After the first shaft 310 and the second shaft 320 penetrate the first fixing member 330, the torque assembly 350 and the second fixing member 340 sequentially and are secured by the two buckles 360, the casing 370 is installed to house the first shaft 310, the second shaft 320, the first fixing member 330, the torque assembly 350 and the second fixing member 340 along a direction from the buckle 360, and the locking member 380 is disposed at the casing 370 and is then locked in the screw hole 345 of the second fixing member 340.

In the present embodiment, the torque assembly 350 is connected to the second fixing member 340 by two positioning protrusions, since the two positioning protrusions (the third positioning protrusion 350c and the fourth positioning protrusion 350d) are respectively located on a side of the torque assembly 350 facing the second fixing member 340 and near the first torque adjustment portion 351 and the second torque adjustment portion 352, the third positioning hole 343 and the fourth positioning hole 344 of the second fixing member 340 correspond to the two positioning protrusions and are located on an upper side and a lower side of the second fixing member 340 respectively. Thus, the second fixing member 340 has the space for the screw hole 345 to be formed between the third positioning hole 343 and the fourth positioning hole 344. The second fixing member 340 has the third positioning hole 343, the fourth positioning hole 344 and the screw hole 345 and therefore can be fixed to the torque assembly 350 and lock up the casing 370. Thus, the second fixing member 340 can have multifunctional effects of positioning and locking simultaneously by the above structure.

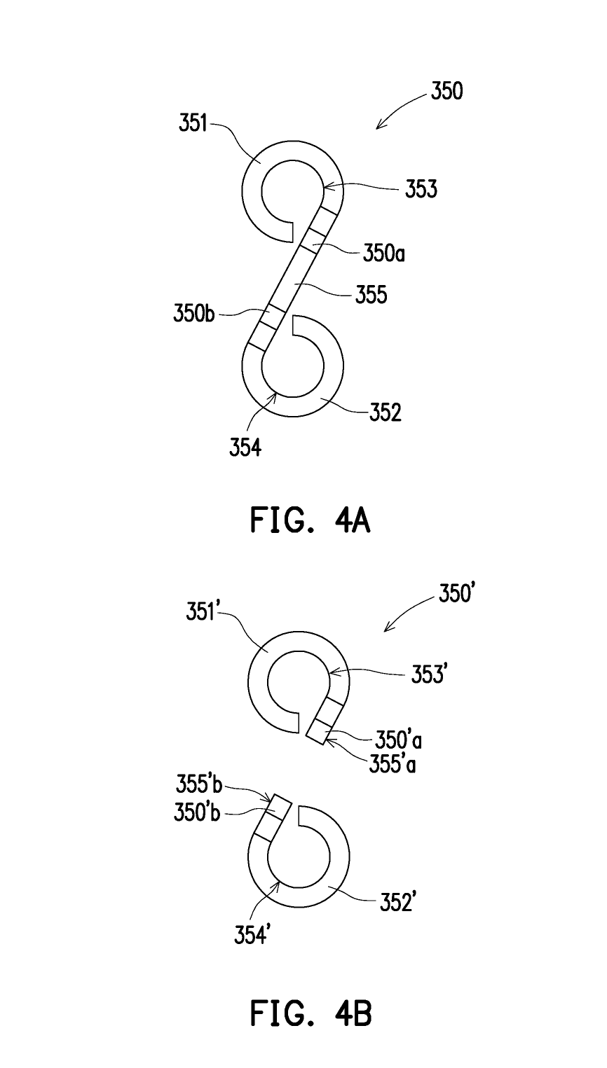

FIGS. 4A and 4B are side views of the torque assembly of the disclosure. Referring to FIGS. 3, 4A and 4B, in FIG. 4A , the torque assembly 350 includes the middle portion 355, and the first torque adjustment portion 351 and the second torque adjustment portion 352 extend from opposite sides of the middle portion 355 respectively. The drawing illustrate an upper right side and a lower left side.

The first positioning protrusion 350a and the second positioning protrusion 350b are located at the middle portion 355, protrude toward the first fixing member 330, and are aligned with the first positioning hole 333 and the second positioning hole 334 respectively. The third positioning protrusion 350c and the fourth positioning protrusion 350d are located at the middle portion 355, protrude toward the second fixing member 340, and are aligned with the third positioning hole 343 and the fourth positioning hole 344 respectively.

In detail, FIG. 4A is a side view viewed from the first fixing member 330 toward the torque assembly 350, wherein the first torque adjustment portion 351 and the second torque adjustment portion 352 extend from one side and another side of the middle portion 355 respectively. The first groove 353 is formed by being surrounded by the first torque adjustment portion 351 from the side of the middle portion 355 along a rotational direction, and the second groove 354 is formed by being surrounded by the second torque adjustment portion 352 from the another side of the middle portion 355 along the same rotational direction.

That is, the first groove 353 and the second groove 354 are formed by being surrounded by the first torque adjustment portion 351 and the second torque adjustment portion 352 respectively from the two sides of the middle portion 355 along the same rotational direction. A side view of the torque assembly 350 has an S-shape or an inverted-S shape. For example, when viewed in the direction of FIG. 4A, the torque assembly 350 shows an inverted-S shape. The first torque adjustment portion 351, the middle portion 355 and the second torque adjustment portion 352 may be integrated components, but the disclosure is not limited thereto.

In addition, the middle portion according to other embodiments may be two components that are separated from each other. Referring to FIG. 4B, a middle portion of a torque assembly 350′ includes a first base 355′a and a second base 355′b that are separated from each other. A first torque adjustment portion 351′ extends from the first base portion 355′a to surround and form a first groove 353′, and a second torque adjustment portion 352′ extends from the second base portion 355′b to surround and form a second groove 354′.

A first positioning protrusion 350′a and a third positioning protrusion 350′c are formed on the first base portion 355′a and protrude toward the first fixing member 330 and the second fixing member 340 respectively, and a second positioning protrusion 350′b and a fourth positioning protrusion 350′d are formed on the second base portion 355b and protrude toward the first fixing member 330 and the second fixing member 340 respectively.

According to the above structure, the torque assembly 350′ can desirably and securely fix the first torque adjustment portion 351′ to the first fixing member 330 and the second fixing member 340 on two sides through the first positioning protrusion 350′a and the third positioning protrusion 350′c on the first base portion 355′a. At the same time, the second torque adjustment portion 352′ can be desirably and securely fixed to the first fixing member 330 and the second fixing member 340 on two sides through the second positioning protrusion 350′b and the fourth positioning protrusion 350′d on the second base portion 355′b.

Therefore, in the present embodiment, the torque assembly 350 (or the torque assembly 350′) of the dual-axle hinge 300 has a plurality of positioning protrusions. Through the positioning protrusions, when the dual-axle hinge 300 rotates, the first shaft 310 and the second shaft 320 can receive independent torque respectively and are not affected by rotation of each other. In addition, the dual-axle hinge 300 can be assembled desirably and securely.

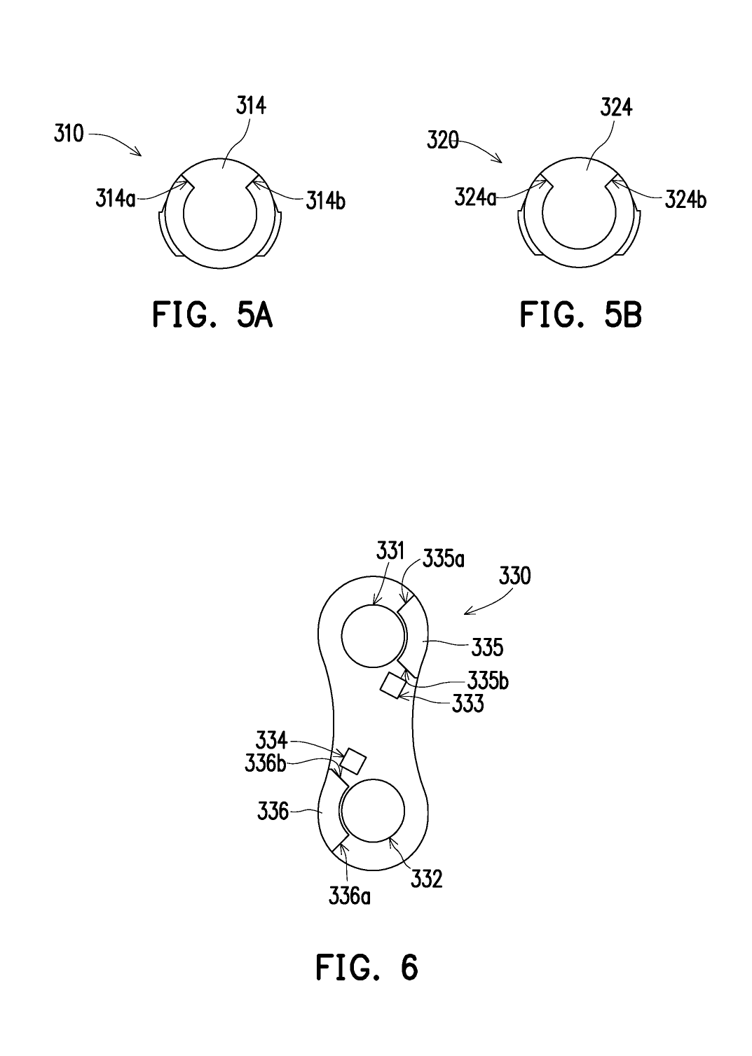

FIGS. 5A and 5B are side views showing the first shaft and the second shaft of the disclosure. FIG. 6 is a side view of the first fixing member of the disclosure. Next, referring to FIGS. 5A, 5B and 6, specifically, FIGS. 5A and 5B are side views viewed from the first fixing member 330 toward the first shaft 310 and the second shaft 320, and FIG. 6 is a side view viewed from the first shaft 310 and the second shaft 320 toward the first fixing member 330.

In the present embodiment, the first shaft 310 includes a first blocking portion 314 that a first surface 314a and a second surface 314b, and the second shaft 320 includes a second blocking portion 324 that has a third surface 324a and a fourth surface 324b, and the first fixing member 330 has a third blocking portion 335 and a fourth blocking portion 336 that correspond to the first blocking portion 314 and the second blocking portion 324 respectively.

The third blocking portion 335 has a first blocking surface 335a and a second blocking surface 335b for abutting against the first surface 314a and the second surface 314b respectively, the fourth blocking portion 336 has a third blocking surface 336a and a fourth blocking surface 336b for abutting against the third surface 324a and the fourth surface 324b respectively. In the present embodiment, the third blocking portion 335 and the fourth blocking portion 336 are adjacent to the first through hole 331 and the second through hole 332 respectively and are located in opposite sides of the first fixing member 330. It is certain that the relative position between the third blocking portion 335 and the fourth blocking portion 336 is not limited thereto.

The third blocking portion 335 of the first fixing member 330 can be rotated between the first surface 314a and the second surface 314b of the first blocking portion 314 of the first shaft 310. The fourth blocking portion 336 of the first fixing member 330 can be rotated between the third surface 324a and the fourth surface 324b of the second blocking portion 324 of the second shaft 320. In the present embodiment, when the top cover 100 is rotated with respect to the host 200, the first blocking portion 314 and the second blocking portion 324 can be used to control rotational sequences and a range of rotational angles of the first shaft 310 and the second shaft 320.

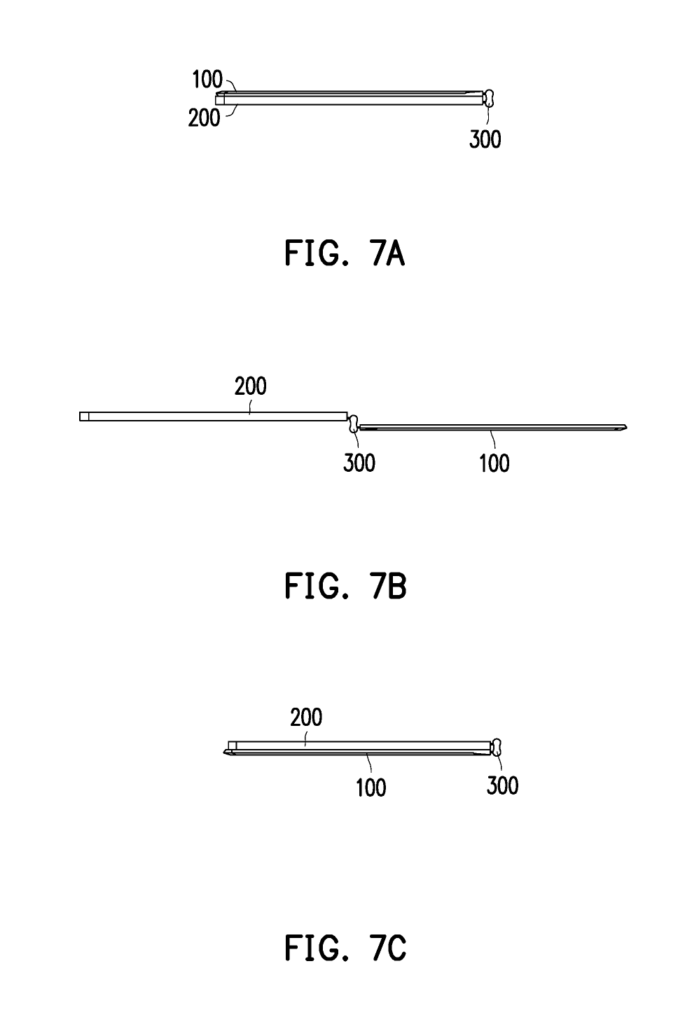

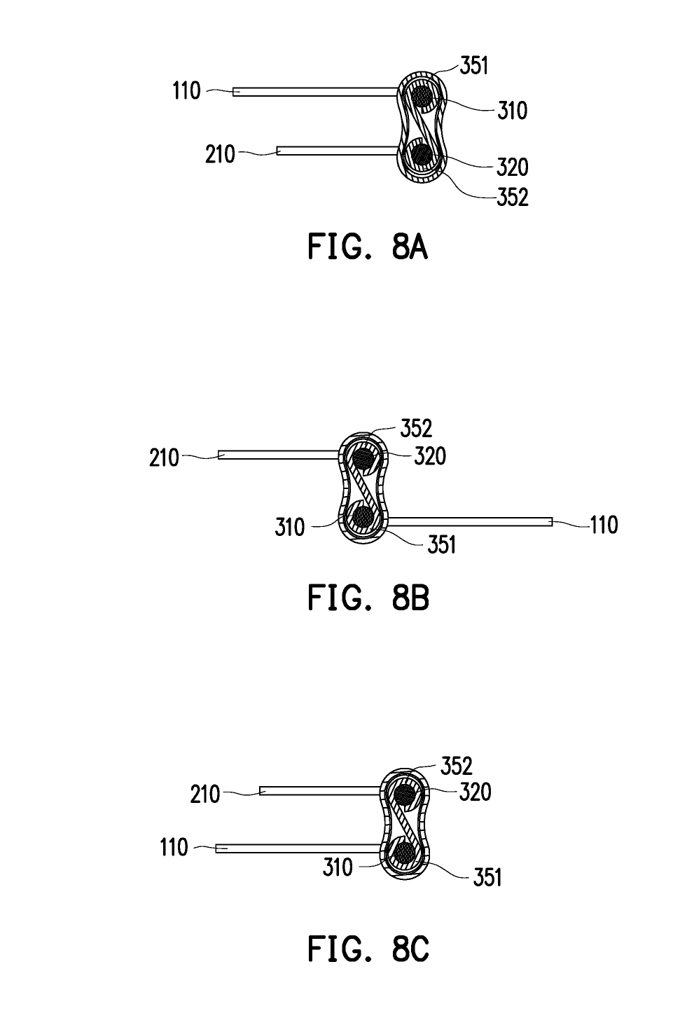

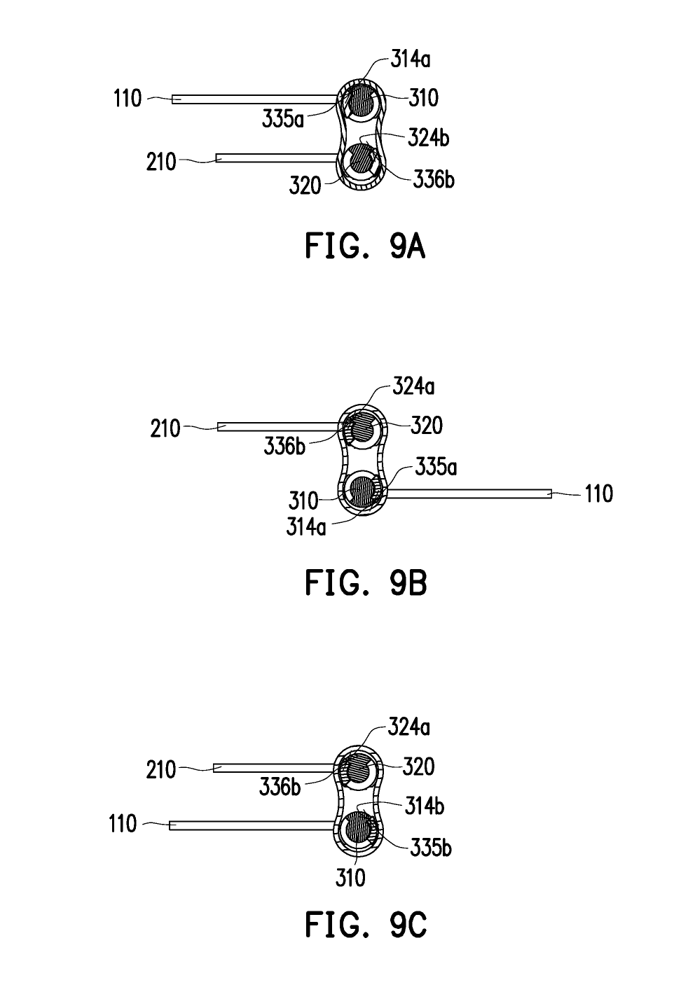

The operation of the dual-axle hinge 300 according to the present embodiment will be described in detail below. FIGS. 7A to 7C are schematic views showing an operating sequence of an electronic device according to the first embodiment of the disclosure. FIGS. 8A to 8C are cross-sectional views showing an operating sequence of a torque assembly of a dual-axle hinge. FIGS. 9A to 9C are cross-sectional views showing an operating sequence of a blocking portion of the dual-axle hinge.

In FIGS. 8A to 8C and 9A to 9C, the top cover 100 and the host 200 according to the present embodiment are connected to the dual-axle hinge 300 respectively through the first locking sheet 110 and the second locking sheet 210 to rotate with respect to each other. Only the first locking sheet 110 and the second blocking sheet 210 are shown as examples in the drawing. Referring to FIGS. 7A, 8A, and 9A first, an electronic device 10 is initially in a state where the angle between the top cover 100 and the host 200 is 0 degree. In this state, the top cover 100 and the host 200 are in a first closed position. At this time, a bottom surface of the top cover 100 faces a top surface of the host 200, and the first surface 314a of the first shaft 310 abuts against the first blocking surface 335a of the third blocking portion 335, and the fourth surface 324b of the second shaft 320 abuts against the fourth blocking surface 336b of the fourth blocking portion 336, as shown in FIG. 9A.

In the present embodiment, as shown in FIG. 8A, when a user is desired to flip the top cover 100 from the first closed position, the first shaft 310 tends to rotate in the same direction as a surrounding direction of the first torque adjustment portion 351, and the first shaft 310 shrinks an opening of the first torque adjustment portion 351 to produce greater torque for the first shaft 310. By contrast, the second shaft 320 tends to rotate in an opposite direction to a surrounding direction of the second torque adjustment portion 352, and the second shaft 320 enlarges an opening of the second torque adjustment portion 352 to produce smaller torque for the second shaft 320. Therefore, in the above case, since the torque received by the first shaft 310 is greater than the torque received by the second shaft 320, the second shaft 320 rotates ahead of the first shaft 310 during the rotation of the top cover 100 from FIG. 8A to FIG. 8B.

That is, when the top cover 100 rotates with respect to the host 200 from the first closed position along the same direction as the surrounding direction of the first torque adjustment portion 351, the torque assembly 350 rotates first with the second shaft 320 that serves as an axis, as shown in FIGS. 8A and 8B. Until the top cover 100 rotates with respect to the host 200 by a first angle (the angle in the present embodiment is 180 degrees, but the disclosure is not limited thereto), the third surface 324a of the second shaft 320 abuts against the third blocking surface 336a of the fourth blocking portion 336, and the first surface 314a of the first shaft 310 still abuts against the first blocking surface 335a of the third blocking portion 335, as shown in FIG. 9B.

In detail, during the process in which the top cover 100 rotates in the first closed position and then rotates by the first angle, the fourth blocking portion 336 rotates with respect to the second blocking portion 324 of the second shaft 320 by the first angle, as shown in FIGS. 9A and 9B. Ultimately, the electronic device 10 is in an open state as in FIG. 7B.

In the state where the angle between the top cover 100 and the host 200 are the first angle (the angle in the present embodiment is 180 degrees, but the disclosure is not limited thereto), if the top cover 100 continues to rotate along the same direction as the surrounding direction of the first torque adjustment portion 351, since the third surface 324a of the second shaft 320 abuts against the third blocking surface 336a of the fourth blocking portion 336, the torque assembly 350 cannot continue to rotate with the second shaft 320 that serves as an axis. At this time, the torque assembly 350 completes subsequent rotating operation with the first shaft 310 that serves as an axis.

That is, when the third surface 324a of the second shaft 320 abuts against the third blocking surface 336a of the fourth blocking portion 336, and the top cover 100 rotates with respect to the host 200 along the same direction as the surrounding direction of the first torque adjustment portion 351, the torque assembly 350 rotates with the first shaft 310 that serves as an axis (as shown in FIGS. 8B and 8C), and the third surface 324a of the second shaft 320 keeps abutting against the third blocking surface 336a of the fourth blocking portion 336 (as shown in FIGS. 9B and 9C). Until a top surface of the top cover 100 faces a bottom surface of the host 200, the top cover 100 and the host 200 are in a second closed position, and the second surface 314b of the first shaft 310 abuts against the second blocking surface 335b of the third blocking portion 335, as shown in FIG. 9C.

In other words, during the process where the top cover 100 rotates from the first angle to the second closed position, the third blocking portion 335 rotates with respect to the first blocking portion 314 by the first angle, as shown in FIGS. 9B and 9C, and therefore the electronic device 10 is in closed state as in FIG. 7C.

Similarly, if the user is desired to restore the electronic device 10 from the second closed position to the first closed position, the top cover 100 rotates from the second closed position and along an opposite direction to the surrounding direction of the first torque adjustment portion 351, and the torque assembly 350 rotates first with the first shaft 310 that serves as an axis until the torque assembly 350 rotates to the first angle and then rotates with the second shaft 320 that serves as an axis. The electronic device 10 returns from the states in FIGS. 7C, 8C and 9C to the states in FIGS. 7A, 8A and 9A.

In addition, in the present embodiment, in the state where the electronic device 10 of FIG. 7A is in the first closed position, a vertical extending direction of the dual-axle hinge 300 is parallel to surface normal directions of the top cover 100 and the host 200, but the disclosure is not limited thereto.

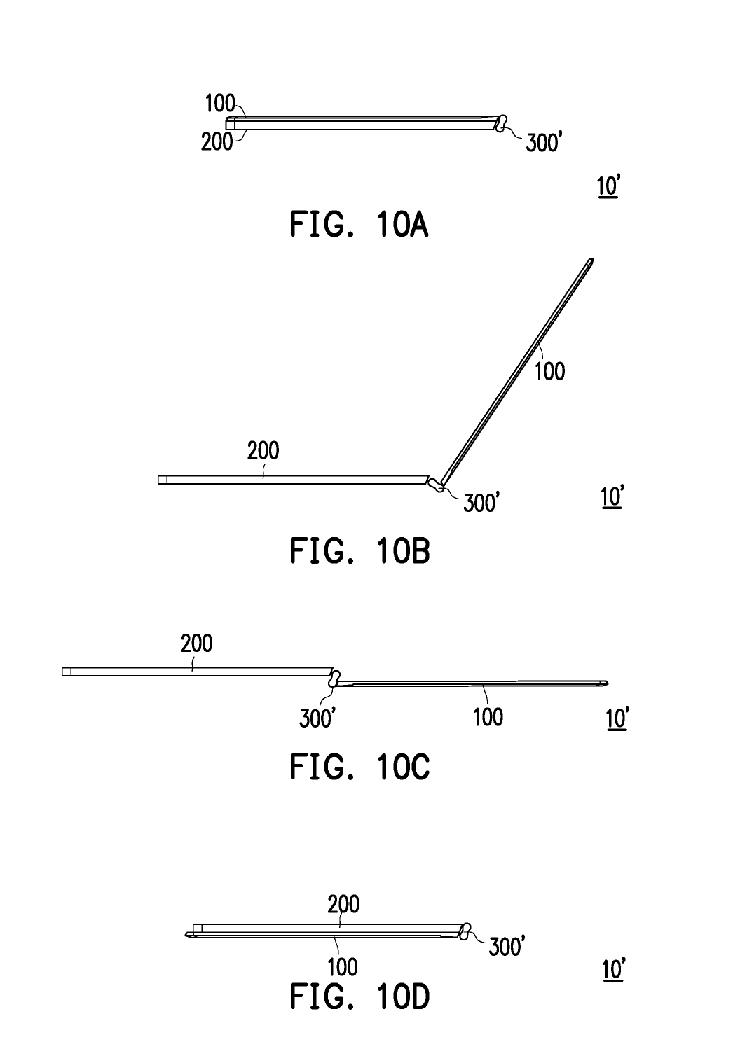

FIGS. 10A to 10D schematically illustrate an operating sequence of an electronic device according to the second embodiment of the disclosure. Referring to FIGS. 10A to 10D, a dual-axle hinge 300′ of an electronic device 10′ according to the present embodiment is inclined to the top cover 100 and the host 200 respectively in the first closed position. As shown in FIG. 10B, when the top cover 100 rotates from the first closed position with respect to the host 200, the dual-axle hinge 300′ can serve as a base to raise one end of the electronic device 10′ before the top cover 100 rotates to be at an angle of 180 degrees (see the state in FIG. 10B). Thus, it becomes convenient for the user to operate the electronic device. The subsequent rotational principle is the same for the previous embodiment, and therefore repeated descriptions are omitted.

In summary of the above, the dual-axle hinge of the electronic device of the disclosure allows the top cover and the host of the electronic device to rotate 360 degrees with respect to each other. In addition, since the torque assembly is fixed to the first positioning hole and the second positioning hole of the first fixing member through the first positioning protrusion and the second positioning protrusion, the torque assembly can be desirably and securely fixed to the first fixing member. In an embodiment, the torque assembly is further fixed to the third positioning hole and the fourth positioning hole of the second fixing member through the third positioning protrusion and the fourth positioning protrusion, therefore the torque assembly can be desirably and securely fixed to the fixing members at two sides. In addition, the above design can reduce the likelihood that the torque received by the first shaft and the torque received by the second shaft affects each other. In addition, since the dual-axle hinge of the present application makes the torque received by the first shaft and the second shaft independent, when the user rotates the top cover and the host of the electronic device, the two axles can receive different torque caused by the difference between the rotational direction of the two axles and the surrounding direction of the torque adjustment portion to control the rotational sequences of the two axles.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A dual-axle hinge, comprising:
a first shaft;
a second shaft;
a first fixing member, comprising a first through hole, a second through hole, a first positioning hole and a second position hole, the first positioning hole and the second position hole being located between the first through hole and the second through hole; and
a torque assembly, comprising a first torque adjustment portion, a second torque adjustment portion, a middle portion, a first positioning protrusion, and a second positioning protrusion, wherein the first torque adjustment portion and the second torque adjustment portion are connected to two sides of the middle portion respectively, and the first positioning protrusion and the second positioning protrusion are disposed at the middle portion respectively and protrude toward the first positioning hole and the second positioning hole, and wherein the first torque adjustment portion has a first groove, the second torque adjustment portion has a second groove, the first shaft passes through the first through hole and the first groove sequentially, and the second shaft passes through the second through hole and the second groove sequentially.

2. The dual-axle hinge of claim 1, further comprising:
a second fixing member, wherein the torque assembly is located between the first fixing member and the second fixing member, the second fixing member comprises a third through hole, a fourth through hole, a third positioning hole and a fourth positioning hole, the third positioning hole and the fourth positioning hole is located between the third through hole and the fourth through hole, and the torque assembly comprises a third positioning protrusion and a fourth positioning protrusion that are fixed to the third positioning hole and the fourth positioning hole respectively, and wherein the first shaft passes through the first through hole, the first groove, and the third through hole sequentially, and the second shaft passes through the second through hole, the second groove, and the fourth through hole sequentially.

3. The dual-axle hinge of claim 2, wherein the third positioning protrusion and the fourth positioning protrusion are located at the middle portion respectively and protrude toward the second fixing member.

4. The dual-axle hinge of claim 1, wherein the first torque adjustment portion and the second torque adjustment portion have plate-like structures, and the first groove and the second groove are formed by being surrounded by the first torque adjustment portion and the second torque adjustment portion respectively from the two sides of the middle portion along the same rotational direction.

5. The dual-axle hinge of claim 2, wherein the middle portion includes a first base and a second base that are separated, the first torque adjustment extends from the first base, the first positioning protrusion and the third positioning protrusion are formed on the first base respectively and protrude toward the first fixing member and the second fixing member respectively, the second torque adjustment portion extends from the second base, and the second positioning protrusion and the fourth positioning protrusion are formed on the second base respectively and protrude toward the first fixing member and the second fixing member respectively.

6. The dual-axle hinge of claim 1, wherein the first shaft comprises a first blocking portion, the first blocking portion comprises a first surface and a second surface, the second shaft comprises a second blocking portion, the second blocking portion comprises a third surface and a fourth surface, the first fixing member comprises a third blocking portion and a fourth blocking portion that correspond to the first blocking portion and the second blocking portion respectively, the third blocking portion comprising a first blocking surface and a second blocking surface that abut against the first surface and the second surface respectively and the fourth blocking portion comprising a third blocking surface and a fourth blocking surface that abut against the third surface and the fourth surface respectively.

7. The dual-axle hinge of claim 2, further comprising at least two buckles, wherein the first shaft comprises a first engaging groove, the second shaft comprises a second engaging groove, the buckles and the torque assembly are located at opposite sides of the second fixing member, and the buckles are disposed in the first engaging groove of the first shaft and the second engaging groove of the second shaft respectively.

8. The dual-axle hinge of claim 7, further comprising a casing and a locking member, wherein the second fixing member further comprises a screw hole, the screw hole is located between the third positioning hole and the fourth positioning hole, the casing houses the first shaft, the second shaft, the first fixing member, the torque assembly and the second fixing member, and the locking member passes through the casing to be locked to the screw hole of the second fixing member.

9. An electronic device, comprising:
a top cover;
a host; and
a dual-axle hinge, the top cover being pivoted to the host through the dual-axle hinge, the dual-axle hinge comprising:
a first shaft, connected to the top cover;
a second shaft, connected to the host;
a first fixing member, comprising a first through hole, a second through hole, a first positioning hole and a second positioning hole that are located between the first through hole and the second through hole; and
a torque assembly, comprising a first torque adjustment portion, a second torque adjustment portion, a middle portion, a first positioning protrusion and a second positioning protrusion, wherein the first torque adjustment portion and the second torque adjustment portion are connected to two sides of the middle portion respectively, the first positioning protrusion and the second positioning protrusion are disposed at the middle portion respectively and protrude toward the first positioning hole and the second positioning hole, wherein the first torque adjustment portion has a first groove, the second torque adjustment portion has a second groove, the first shaft passes through the first through hole and the first groove sequentially, and the second shaft passes through the second through hole and the second groove sequentially.

10. The electronic device of claim 9, wherein the dual-axle hinge further comprises a second fixing member, the torque assembly is located between the first fixing member and the second fixing member, the second fixing member comprises a third through hole, a fourth through hole, a third positioning hole and a fourth positioning hole that are located between the third through hole and the fourth through hole, the torque assembly comprises a third positioning protrusion and a fourth positioning protrusion that are fixed to the third positioning hole and the fourth positioning hole respectively, the first shaft passes through the first through hole, the first groove and the third through hole sequentially, and the second shaft passes through the second through hole, the second groove and the fourth through hole sequentially.

11. The electronic device of claim 10, wherein the third positioning protrusion and the fourth positioning protrusion are located at the middle portion respectively and protrude toward the second fixing member.

12. The electronic device of claim 9, wherein the first torque adjustment portion and the second torque adjustment portion have plate-like structures, and the first groove and the second groove are formed by being surrounded by the first torque adjustment portion and the second torque adjustment portion respectively from the two sides of the middle portion along the same rotational direction.

13. The electronic device of claim 10, wherein the middle portion comprises a first base and a second base separated from each other, the first torque adjustment portion extends from the first base, the first positioning protrusion and the third positioning protrusion are formed on the first base respectively and protrude toward the first fixing member and the second fixing member respectively, the second torque adjustment portion extends from the second base, and the second positioning protrusion and the fourth positioning protrusion are formed on the second base respectively and protrude toward the first fixing member and the second fixing member respectively.

14. The electronic device of claim 9, wherein the first shaft comprises a first blocking portion, the first blocking portion comprises a first surface and a second surface, the second shaft comprises a second blocking portion, the second blocking portion comprises a third surface and a fourth surface, the first fixing member comprises a third blocking portion and a fourth blocking portion that correspond to the first blocking portion and the second blocking portion respectively, the third blocking portion comprises a first blocking surface and a second blocking surface that abut against the first surface and the second surface respectively, and the fourth blocking portion comprises the third blocking surface and the fourth blocking surface that abut against the third surface and the fourth surface respectively.

15. The electronic device of claim 14, wherein when the top cover and the host are in a first closed position, a bottom surface of the top cover faces a top surface of the host, the first surface abuts against the first blocking surface, and the fourth surface abuts against the fourth blocking face; when the top cover is rotated with respect to the host from the first closed position along the same direction as a surrounding direction of the first torque adjustment portion, the torque assembly rotates with the second shaft which serves as an axis until the top cover is rotated with respect to the host by a first angle, the third surface abuts against the third blocking surface, and the first surface abuts against the first blocking face.

16. The electronic device of claim 15, wherein when the third face abuts against the third blocking surface, and the top cover is rotated with respect to the host along the same direction as the surrounding direction of the first torque adjustment portion, the torque assembly rotates with the first shaft that serves as an axis until a top surface of the top cover faces a bottom surface of the host, the top cover and the host are in a second closed position, and the second surface abuts against the second blocking surface.

17. The electronic device of claim 10, wherein the dual-axle hinge further comprises at least two buckles, the first shaft comprises a first engaging groove, the second shaft comprises a second engaging groove, the buckles and the torque assembly are located at opposite sides of the second fixing member, and the buckles are disposed in the first engaging groove of the first shaft and the second engaging groove of the second shaft respectively.

18. The electronic device of claim 17, wherein the dual-axle hinge further comprises a casing and a locking member, the second fixing member further comprises a screw hole, the screw hole is located between the third positioning hole and the fourth positioning hole, the casing houses the first shaft, the second shaft, the first fixing member, the torque assembly and the second fixing member, and the locking member passes through the casing to be locked to the screw hole of the second fixing member.
